(19) United States
(12) Patent Application Publication
(10) Pub. No.: US 2009/0185310 A1
(43) Pub. Date: Jul. 23, 2009

(54) Method for Providing Contaminant Prevention and Removal from a Tape Drive System

(76) Inventors: Allen Keith Bates, Tucson, AZ (US); Nhan X. Bui, Tucson, AZ (US); Kevin B. Judd, Tucson, AZ (US); Daniel J. Winarski, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 12/017,206

(22) Filed: Jan. 21, 2008

(51) Int. Cl. G11B 33/14

(52) U.S. Cl. 360/97.02; G9B/33.035

(57) ABSTRACT

A method for preventing dust from entering a tape drive system is disclosed. Initially, a cooling fan is allowed to rotate in one direction to provide airflow to the tape drive system. In response to a detection of a loading or unloading of a tape cartridge or a head brush operation, the cooling fan is allowed to rotate in a different direction to provide airflow in an opposite direction in order to blow any dust and debris, which may be introduced from a tape cartridge or may already be resident on a tape head, out the front of the tape drive system.

### BACKGROUND OF THE INVENTION

1. Technical Field

The present invention relates to data storage systems in general, and more particularly, to tape drive systems. Still more particularly, the present invention relates to a method for preventing dust from entering a tape drive system and for removing dust after the dust has gotten into the tape drive system.

2. Description of Related Art

During the insertion of a tape cartridge into a tape drive system, contaminants, such as dust, can be pulled into the tape drive system from the loading area in which the tape cartridge is inserted. When the tape cartridge is subject to a load/unload operation, dust that has accumulated around the tape cartridge in the loading area is disturbed and may be drawn into the tape drive system by a cooling fan. The dust may eventually be deposited on a read/write tape head of the tape drive system. In time, the dust may cause the tape drive system to suffer failures due to the inability to read servo landmark information and/or read and write data.

Consequently, it would be desirable to provide a method for preventing dust from entering a tape drive system and for removing dust after the dust has gotten into the tape drive system.

### SUMMARY OF THE INVENTION

In accordance with a preferred embodiment of the present invention, a cooling fan is allowed to rotate in one direction to provide airflow to the tape drive system. In response to a detection of a loading or unloading of a tape cartridge or a head brush operation, the cooling fan is allowed to rotate in a different direction to provide airflow in an opposite direction in order to blow any dust and debris out the front of the tape drive system.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is an isometric view of a tape drive system, in accordance with a preferred embodiment of the present invention;

FIG. 2 is a high-level logic flow diagram of a method for preventing contaminant from entering the tape drive system from FIG. 1, in accordance with a preferred embodiment of the present invention; and

FIG. 3 is a diagram of a leader block path, in accordance with a preferred embodiment of the present invention.

### DETAILED DESCRIPTION OF A PREFERRED EMBODIMENT

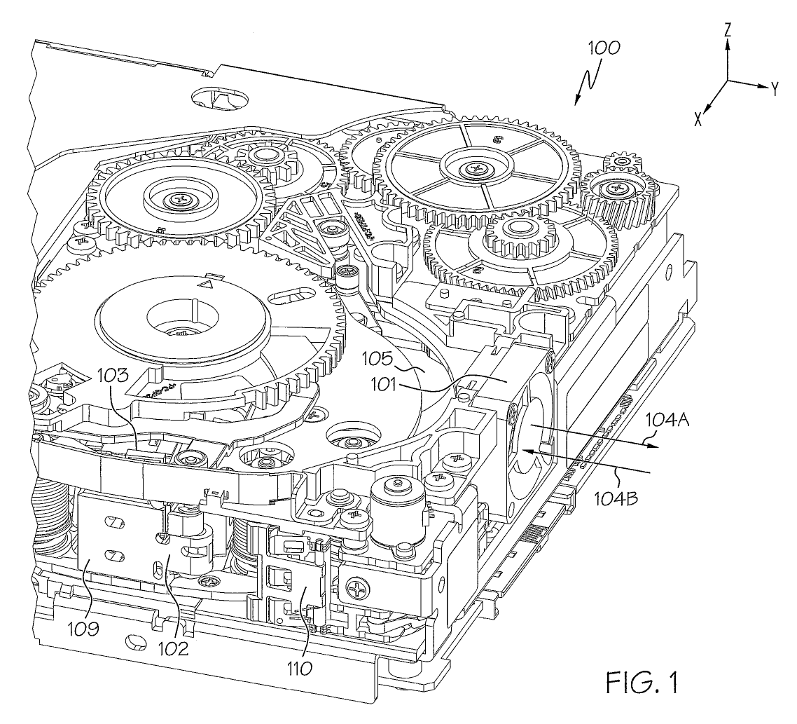

With reference now to the drawings, and in particular to FIG. 1, there is illustrated an isometric view of a tape drive system in which a preferred embodiment of the present invention is incorporated. As shown, a tape drive system 100 includes a fan 101 that provides airflow, a leader block 102, a tape head 103 and a head brush 110 for cleaning tape head 103. A leader block path 105 shows the path of modified leader block 102 being located directly in front of fan 101. Airflow provided by fan 101 normally comes out the back of tape drive system 100 in a direction 104A of the +Y axis, for the purpose of cooling tape drive system 100 by pulling hot air out of tape drive system 100.

In accordance with a preferred embodiment of the present invention, the airflow direction of fan 101 within tape drive system 100 is temporarily reversed, along the −Y axis as shown by a direction 104B, during a loading/unloading of a tape cartridge in order to blow dust out of tape drive system 100 that may be introduced by the tape cartridge itself. After the loading/unloading of the tape cartridge, fan 101 is returned to the normal airflow direction 104A, for the purposes of providing cooling. In addition, leader block 102 is moved in front of fan 101 during the time head brush 110 cleans head 103. With the airflow direction of fan 101 being reversed, dust will be directed by leader block 102 towards head brush 110 and tape head 103, and the dust will be blown from head brush 110 and tape head 103, and out of the front of tape drive system 100.

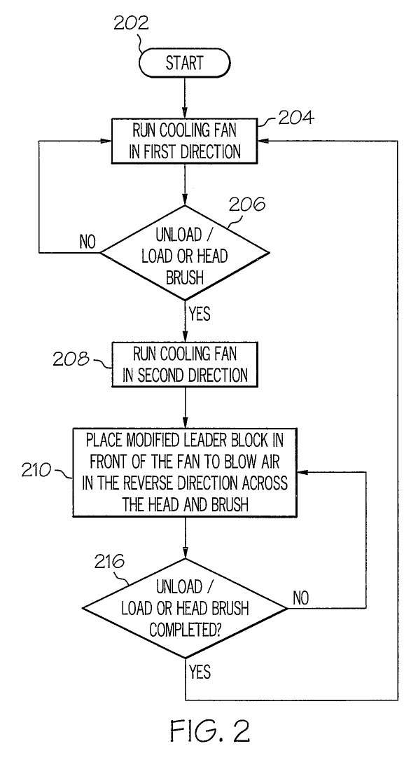

With reference now to FIG. 2, there is depicted a high-level logic flow diagram of a method for preventing contaminants from entering tape drive system 100 of FIG. 1, in accordance with a preferred embodiment of the present invention. The contaminants can be dust, dirt, airborne particles, smoke, tape debris, cartridge debris, etc. Starting at block 202, a cooling fan is allowed to rotate in a first (default) direction, as shown in block 204. A determination is then made whether or not a tape cartridge load/unload or head brush operation is detected, as depicted in block 206. If a tape cartridge load/unload or head brush operation is not detected, the process returns to block 204. Otherwise, if a tape cartridge load/unload or head brush operation is detected, the fan direction is selectively allowed to rotate in a second direction (which is opposite of the first direction) in order to blow air out the front of the tape drive system while the tape cartridge is being loaded or unloaded, as depicted in block 208, so that dust cannot be introduced by the tape cartridge. As a result, dust and debris are blown out the front of the tape drive system in cooperation with the physical movement of the cartridge out the front of the tape drive system.

In addition, a head brush, such as head brush 110 from FIG. 1, is also activated to clean a tape head, such as tape head 103 from FIG. 1, and then a leader block, such as leader block 102 from FIG. 1, is moved along a leader block path, such as leader block path 105 from FIG. 1, to be in front of the fan, as shown in block 210, in order to direct airflow direction 104B from the fan past the head brush and the tape head, to blow dust off the tape head and the head brush, and out the front of the tape drive system.

A determination is made whether or not the tape cartridge load/unload or head brush operation has been completed, as shown in block 216. If the tape cartridge load/unload or head brush operation has not been completed, the process returns to block 210. Otherwise, if the tape cartridge load/unload or head brush operation has been completed, the process returns to block 204 to allow the fan to rotate in a first direction such that the airflow direction of the fan is returned to its normal setting, i.e., out the back of the tape drive.

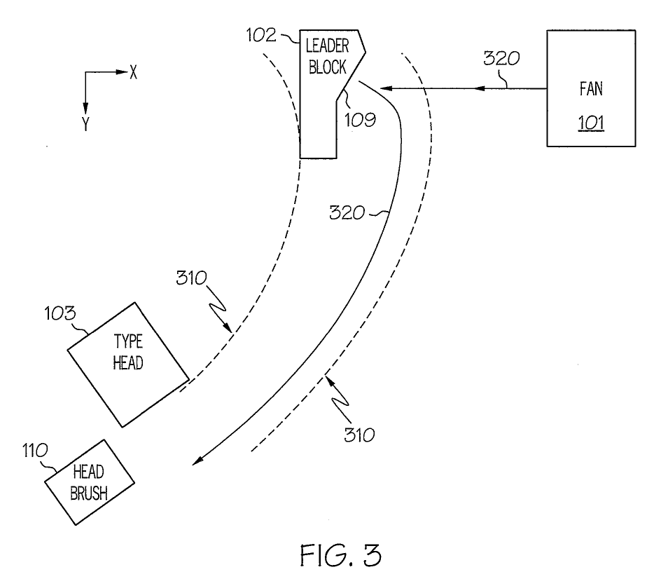

Referring now to FIG. 3, there is illustrated a diagram of a leader block path, in accordance with a preferred embodiment of the present invention. As shown, a leader block path 310 is designed to direct air to tape head 103 and head brush 110. In addition, leader block 102 may include a curved or slanted surface 109, which is different from conventional leader blocks that only have surfaces meeting at essentially right angles. Slanted surface 109 of leader block 102 allows airflow 320 from fan 101 to be more efficiently deflected to travel along leader block path 310 for cleaning tape head 103 and head brush 110.

As has been described, the present invention provides a method for preventing contaminants from entering a tape drive system.

While an illustrative embodiment of the present invention has been described in the context of a fully functional tape drive system, those skilled in the art will appreciate that the software aspects of an illustrative embodiment of the present invention are capable of being distributed as a computer program product in a variety of forms, and that an illustrative embodiment of the present invention applies equally regardless of the particular type of media used to actually carry out the distribution. Examples of the types of media include recordable type media such as solid-state thumb drives, floppy disks, hard disk drives, CD ROMs, DVDs, ultra-density optical disk, and transmission type media such as digital and analog communication links. These communication links may involve, including without limitation a Fibre Channel loop, Small Computer System Interface (SCSI), Internet SCSI (iSCSI), Serial Attach SCSI (SAS), Fibre Channel, SCSI over Fibre Channel, Ethernet, Fibre Channel over Ethernet (FCoE), Infiniband, and Serial ATA (SATA) over optical fibre or copper.

While the invention has been particularly shown and described with reference to a preferred embodiment, it will be understood by those skilled in the art that various changes in form and detail may be made therein without departing from the spirit and scope of the invention.

What is claimed is:

1. A method for preventing contaminants from entering a tape drive system, said method comprising:
detecting an unloading of a tape cartridge; and
in response to a detection of said tape cartridge being unloaded, enabling a fan to rotate in a direction to provide airflow in a direction to blow contaminants out of said tape drive system.

2. The method of claim 1, wherein said method further includes
detecting a loading of said tape cartridge; and
in response to a detection of said tape cartridge being loaded, enabling said fan to rotate in a direction to provide airflow in a direction to blow contaminants out of said tape drive system.

3. The method of claim 1, wherein said method further includes
detecting a tape head cleaning operation; and
in response to a detection of said tape head being cleaned, enabling said fan to rotate in a direction to provide airflow in a direction to blow contaminants from said tape head.

4. The method of claim 3, wherein said method further includes placing a leader block to direct airflow from said fan to blow contaminants from said tape head.

5. The method of claim 4, wherein said leader block is modified with a slanted surface to direct airflow.

6. The method of claim 3, wherein said method further includes placing a leader block to direct airflow from said fan to said tape head along a leader block path.

7. The method of claim 6, wherein said leader block is modified with a slanted surface to direct airflow.

8. The method of claim 3, wherein said method further includes placing a leader block to direct airflow from said fan to a tape head brush along a leader block path.

9. The method of claim 8, wherein said tape drive system further includes a leader block which is modified with a slanted surface to direct airflow.

10. A tape drive system comprising:
a detector for detecting an unloading of a tape cartridge; and
a fan, in response to a detection of said tape cartridge being unloaded, rotates in a direction to provide airflow in a direction to blow contaminants out of said tape drive system.

11. The tape drive system of claim 10, wherein said fan, in response to a detection of said tape cartridge being loaded, rotates in a direction to provide airflow in a direction to blow contaminants out of said tape drive system.

12. The tape drive system of claim 10, wherein said fan, in response to a detection of said tape head being cleaned, rotates in a direction to provide airflow in a direction to blow contaminants from said tape head.

13. The tape drive system of claim 12, wherein said tape drive system further includes a leader block being placed to direct airflow from said fan to blow contaminants from said tape head.

14. The tape drive system of claim 13, wherein said leader block is modified with a slanted surface to direct airflow.

15. The tape drive system of claim 12, wherein said tape drive system further includes a leader block being placed to direct airflow from said fan to said tape head along a leader block path.

16. The tape drive system of claim 15, wherein said leader block is modified with a slanted surface to direct airflow.

17. The tape drive system of claim 12, wherein said tape drive system further includes a leader block being placed to direct airflow from said fan to a tape head brush along a leader block path.

18. The tape drive system of claim 17, wherein said leader block is modified with a slanted surface to direct airflow.
